(19) United States
(12) Patent Application Publication
(10) Pub. No.: US 2018/0311944 A1
(43) Pub. Date: Nov. 1, 2018

(54) POLYMERIC BLENDS AND USES THEREOF FOR MAKING TRANSPARENT RIGID AND HEAT-RESISTANT THERMOPLASTIC WORKPIECES

(71) Applicant: JMS INTERNATIONAL PACKAGING INC., Orford (CA)

(72) Inventor: Marc LEBLANC, Orford (CA)

(73) Assignee: JMS INTERNATIONAL PACKAGING INC., Orford, QC (CA)

(21) Appl. No.: 15/560,012

(22) PCT Filed: Jul. 7, 2017
(86) PCT No.: PCT/IB2017/054122

§ 371 Date: Sep. 20, 2017

Related U.S. Application Data
(60) Provisional application No. 62/445,916, filed on Jan. 13, 2017.

(30) Foreign Application Priority Data
Jul. 7, 2016 (CA) 2935643

(51) Int. Cl. B32B 27/36; C08L 67/02

(52) U.S. Cl. CPC B32B 27/36; C08L 67/02; C08L 2203/10; B65D 81/266; B32B 2439/66; C08K 2201/012; B32B 2439/60

(57) ABSTRACT

Polymeric blends and thermoplastic compositions which can be used for making thermoplastic workpieces are provided. The polymeric blends and thermoplastic compositions comprise a copolyester and an oxygen scavenging polyester, and optionally an oxidation catalyst. These blends and compositions may be used for making heat-resistant rigid and transparent containers having a low gas permeability. These thermoplastic workpieces and containers may find numerous applications for food, beverage, medical, pharmaceuticals and cosmetic products, as well as for any other application for which it is desirable to inhibit exposure to oxygen during storage. Particular examples provided are bottles and jugs particularly that are useful for hot fill applications.

### FIELD OF THE INVENTION

The invention relates to the field of thermoplastic, and more particularly to polymeric blends useful for making thermoplastic workpieces such as heat-resistant rigid and transparent containers having a low gas permeability.

### BACKGROUND OF THE INVENTION

Plastic materials have been replacing glass and metal packaging materials due to their lighter weight, decreased breakage compared to glass and potentially lower cost. However, one major deficiency with plastic materials is their relatively high gas permeability compared to glass. Because atmospheric oxygen is a substance that reduces shelf-life of a packaged product, the uses of plastic containers in the food and pharmaceutical industries have been limited. Also, not all types of plastic are safe when contacted with food, especially in the long term.

Another challenge exists in the manufacture of heat-resistant plastic that are transparent containers. Existing transparent plastic containers melt at low temperature (i.e. <65° C.) and for that reason they have not been used yet for applications wherein the food products are packaged at a high temperature (e.g. canning at 85-121° C.).

Accordingly, there is a need for plastic compositions that can be used for the manufacture of various thermoplastic workpieces, particularly the manufacture of heat-resistant transparent and rigid plastic containers.

There is also a need for plastic compositions that can be used for the manufacture of rigid thermoplastic workpieces having a gas permeability comparable to glass.

There is also a need for rigid transparent heat-resistant thermoplastic containers having a low gas permeability for the storage food and other products that are sensitive to ambient air.

The present invention addresses these needs and other needs as it will be apparent from review of the disclosure and description of the features of the invention hereinafter.

### BRIEF SUMMARY OF THE INVENTION

According to one aspect, the invention relates to a polymeric blend comprising a copolyester and an oxygen scavenging polyester.

According to one particular aspect, the invention relates to a polymeric blend comprising: a copolyester and an oxygen scavenging polyester, wherein said copolyester and said oxygen scavenging polyester are compatible for mixing, and wherein said copolyester has a deflection temperature of at least 81° C.@1.82 MPa and/or a deflection temperature of at least 94° C.@0.455 MPa.

According to one particular aspect, the invention relates to a polymeric blend comprising Eastman Copolyester Tritan TX1800™ and about 1.5-3% w/w of Polyone Colormatrix Amosorb™.

According to another particular aspect, the invention relates to a polymeric blend comprising JMS808™, OxyClear® Resin 3500 and OxyClear® masterbatch 2710.

According to another aspect, the invention relates to a melted thermoplastic composition comprising a mixture of (i) a melted copolyester and (ii) a melted oxygen scavenging polyester, wherein the melted plastic composition has a melting temperature of about 230° C. to about 265° C.

According to a further aspect, the invention relates to a thermoplastic workpiece comprising a thermoplastic monolayer composed of at least (i) a copolyester and (ii) an oxygen scavenging polyester. A related aspect concerns a method of manufacturing a thermoplastic workpiece comprising preparing the polymeric blend according to the invention and mechanically shaping the thermoplastic workpiece.

According to another aspect, the invention relates to a thermoplastic container comprising a thermoplastic monolayer composed of a mixture of at least (i) a copolyester and (ii) about 0.5% w/w to about 5% w/w of an oxygen scavenging polyester.

According to one particular aspect, the invention relates to a thermoplastic container in the form of a bottle, a can or a jug, the container comprising a thermoplastic monolayer composed of a mixture of Eastman Copolyester Tritan TX1800™ and about 0.5% w/w to about 5% w/w of Polyone Colormatrix Amosorb™. According to another particular aspect, the container comprising a thermoplastic monolayer composed of a mixture of JMS808™, OxyClear® Resin 3500 and OxyClear® masterbatch 2710.

In preferred embodiments, the copolyester has a deflection temperature of at least 81° C.@1.82 MPa and/or a deflection temperature of at least 94° C.@0.455 MPa.

According to another aspect, the invention relates to a method for storing a product (e.g. an air-sensitive product), the method comprising the steps of: (a) providing the thermoplastic container according to the invention; (b) placing the product into the thermoplastic container; and (c) hermetically sealing the thermoplastic container.

According to another aspect, the invention relates to method of manufacturing a thermoplastic workpiece comprising:
melting and mixing (i) an amorphous copolyester having a deflection temperature of at least 81° C.@1.82 MPa and/or a deflection temperature of at least 94° C.@0.455 MPa with (ii) a compatible oxygen scavenging polyester for obtaining a polymeric blend as defined herein; and
mechanically shaping the polymeric blend into said thermoplastic workpiece.

An advantage of the polymeric blends and melted thermoplastic compositions according to the invention is that they are particularly useful in the manufacture of heat-resistant transparent and rigid thermoplastic workpieces, and more particularly in the manufacture of heat-resistant transparent and rigid plastic containers having a very low gas permeability (i.e. almost nil like glass). Such containers make perfect candidates for storing food, beverages, pharmaceuticals, medical products, cosmetic products, cleansing products, and other products that are sensitive to ambient air.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE FIGURES

In order that the invention may be readily understood, embodiments of the invention are illustrated by way of example in the accompanying drawings.

FIG. 1A is a side perspective view of a thermoplastic jug manufactured according to one embodiment of the present invention. The dimensions are in millimeters.

FIG. 1B is a side cut view along the dotted line of FIG. 1A, of a thermoplastic jug manufactured according to one embodiment of the present invention, showing thickness (in millimeters) of different sections of the jug.

FIG. 1C is a side perspective view of the neck of a thermoplastic jug manufactured according to one embodiment of the present invention, showing its dimensions and thickness. The provided values are in inches and in millimetres (in parenthesis).

FIG. 2 is a picture of a one liter thermoplastic jug, manufactured according to one embodiment of the present invention, which has been labelled and filled with Canadian maple syrup.

FIG. 3 is a picture of a 387-ml jug, manufactured according to one embodiment of the present invention.

FIG. 4A is a front perspective view of a 387-ml jug manufactured according to one embodiment of the present invention. The dimensions are in inches.

FIG. 4B is a top perspective view of a 387-ml jug manufactured according to one embodiment of the present invention. The dimensions are in inches.

FIG. 4C is a bottom perspective view of a 387-ml jug manufactured according to one embodiment of the present invention.

FIG. 4D is a side cut view along the lines A-A of FIG. 4C, of a 387-ml jug manufactured according to one embodiment of the present invention. The dimensions are in inches.

FIG. 5 is a top perspective view of a square-shaped 1 liter jug, manufactured according to one embodiment of the present invention.

FIG. 6 is a top perspective view of a 567-ml can, manufactured according to one embodiment of the present invention.

Further details of the invention and its advantages will be apparent from the detailed description included below.

### DETAILED DESCRIPTION OF PREFERRED EMBODIMENTS

In the following description of the embodiments, references to the accompanying drawings are by way of illustration of an example by which the invention may be practiced. It will be understood that other embodiments may be made without departing from the scope of the invention disclosed.

General Overview

The present inventors have been able to manufacture thermoplastic containers that are rigid, transparent, heat-resistant and have a very low gas permeability (i.e. a gas permeability comparable to glass). This achievement has been possible by obtaining a polymeric blend made from two existing plastic materials believed to be incompatible: a copolyester and an oxygen scavenging polyester. Without wishing to be bound by theory, the Applicant presumes that the two claimed components were believed to be incompatible by those in the industry, at least because of different melting temperatures of the two components.

Polymeric Blends and Melted Thermoplastic Compositions

Accordingly, one aspect of the present invention relates to a polymeric blend comprising a copolyester and an oxygen scavenging polyester, the copolyester and the oxygen scavenging polyester being compatible for mixing. Various copolyesters and an oxygen scavenging polyesters may be useful according to the present invention.

As used herein, the term “copolyester” refers to one or more typical copolyesters that form when modifications are made to polyesters by using for instance combinations of diacids and diols. For example, by introducing other diacids, such as isophthalic acid (IPA), or other diols such as cyclohexane dimethanol (CHDM) to the polyester polyethylene terephthalate (PET), the material becomes a copolyester due to its comonomer content. Preferably, the copolyester comprises a minimal deflection temperature in order to obtain a final product (e.g. a thermoplastic workpiece or a thermoplastic container) that is heat-resistant. In embodiments, the copolyester is a polyester which has been modified in order to have a desired minimal deflection temperature. In embodiments, the copolyester is a polyester in which its intrinsic viscosity has been increased and/or its molecular weight has been increased, for increasing its deflection temperature.

In embodiments, the copolyester used in the preparation of a polymeric blend of the invention has a deflection temperature of at least 81° C.@1.82 MPa and/or a deflection temperature of at least 94° C.@0.455 MPa. In embodiments, the polymeric blend of the invention has a deflection temperature of at least 82° C., or 83° C., or 84° C., or 85° C., or 86° C., or 87° C., or 88° C., or 89° C., or 90° C., or 91° C., or 92° C., or 93° C., or 94° C., or 95° C. or more @1.82 MPa. In embodiments, the polymeric blend of the invention has a deflection temperature of at least 95° C., or 96° C., or 97° C., or 98° C., or 99° C., or 100° C., or more @0.455 MPa.

Preferably the copolyester is a copolyester that is sold and/or commercially available for blow molding applications. Examples of commercially available copolyesters that are sold for blow molding applications and that have a desired minimal deflection temperature include, but are not limited to, Eastman Copolyester Tritan TX1000™, Eastman Copolyester Tritan TX1001™, Eastman Copolyester Tritan TX1001 ™ Eastman Copolyester Tritan TX1500HF™ Eastman Copolyester Tritan TX1501HF™, Eastman Copolyester Tritan TX1800™, Eastman Copolyester Tritan TX1801™ Eastman Copolyester Tritan TX2000™, Eastman Copolyester Tritan TX2001™ and Eastman Copolyester Tritan TXF1021™.

An additional example of a copolyester according to the present invention is JMS808™, this copolyester comprising the following characteristics:

| Property | Typical Value | Test Method |
|---|---|---|
| Intrinsic Viscosity* | 0.81 ± 0.02 | 1% Solution in |
| | | Dichloroacetic Acid* |
| Melting Point (° C.) | 252 Maximum | DSC** |
| Carboxyl End Groups | 45 Maximum | Titration** |
| (meq/kg) | | |
| Diethylene Glycol Content | 1.8 Maximum | Gas Chromatography** |
| (wt %) | | |
| Acetaldehyde Content (ppm) | 2.5 Maximum | Gas Chromatography** |
| Density (g/cm3) | 1.39 Minimum | Pycnometer |
| Fines (%) | 0.05 (through | Gravimetric |
| | 28 mesh) | determination |
| | | as manufactured |
| Moisture Content (%) | 0.2 Maximum | Karl Fisher Titration |
| | | as manufactured |
| Crystallinity (%) | 50 Minimum | Pycnometer |
| Bulk Density (packed) lb/ft3 | 50 Minimum | *** |
| Chip Size (grams/100 chips) | 2.2 Maximum | |
| Deflection temperature | about 92° C. @ | |
| | 1.82 MPa | |

*Determined by conversion of solution viscosity to intrinsic viscosity using an empirical correlation developed

According to one particular embodiment, the copolyester according to the present invention comprises substantially the same or very similar characteristics as the characteristics defined for JMS808™ above.

Those skilled in the art will be able to identify alternative copolyesters that are acceptable according to the present invention. Preferably, in addition of being heat-resistant and acceptable for molding applications, the copolyester should be amorphous, have a slow rate of crystallisation (thereby providing a low level of shrinking), and result in a formed workpiece that is rigid and resistant to impacts and scratches.

The amount of copolyester present in the polymeric blend may vary according to various factors including, but not limited to, the desired application, the shape and/or thickness of the final thermoplastic workpiece, the type of product to be put in a thermoplastic container and the storage condition, etc. In embodiments, the polymeric blend comprises about 0.1% w/w to about 8% w/w copolyester, or about 0.5% w/w to about 5% w/w, or about 1% w/w to about 3% w/w, or about 1.5% w/w, or about 2% w/w, or about 2.5% w/w, or about 3% w/w. In one preferred embodiment, the polymeric blend comprises about 1.5% w/w copolyester.

At least one of the purpose of the oxygen scavenging polyester is to create a barrier preventing passage of gas molecules (e.g. oxygen from ambient air) through the formed thermoplastic workpiece (e.g. walls of a container). For achieving a proper mixing, preferably until an homogeneous mixture is obtained, the oxygen scavenging polyester needs to be compatible with the copolyester. Preferably the oxygen scavenging polyester is selected from oxygen scavenging polyesters that are compatible with polyethylene terephthalate (PET) applications. Examples of such oxygen scavenging polyesterinclude, but are not limited to, Polyone Colormatrix Amosorb™, Polyone Colormatrix Plus™, Polyone Colormatrix SOLO2™. An additional example of an oxygen scavenging polyester according to the present invention is OxyClear® Resin 3500 by Indorama Ventures/Auriga Polymers Inc. (Charlotte, N.C., USA). In addition and/or in replacement of the oxygen scavenging polyester, the blend and the product(s) thereof may comprise an oxygen scavenger additive such as Polyone Colormatrix Amosorb Hyguard™. Those skilled in the art will be able to identify alternative oxygen scavenging polyesters and/or oxygen scavenger additives that are acceptable according to the present invention.

The amount of oxygen scavenging polyester present in the polymeric blend may vary according to various factors including, but not limited to, the desired application, the shape and/or thickness of the final thermoplastic workpiece, the type of product to be put in a thermoplastic container and the storage condition, etc. In embodiments, the polymeric blend comprises about 0.1% w/w to about 8% w/w oxygen scavenging polyester, or about 0.5% w/w to about 5% w/w, or about 1.5% w/w, or about 2% w/w, or about 2.5% w/w, or about 3% w/w.

Any suitable material can be added to polymeric blend of the invention, including one or more additional polymers. For instance, the polymeric blend may also comprise additives. Possible additives may include, but are not limited to, oxidation catalysts, visible light absorbers, dyes, colorants, metallic oxidation catalysts, fillers, processing aids, plasticizers, fire retardants, anti-fog agents, crystallization aids, impact modifiers, surface lubricants, denesting agents, stabilizers, antioxidants, ultraviolet light absorbing agents, catalyst deactivators, nucleating agents, acetaldehyde reducing compounds, reheat enhancing aids, anti-abrasion additives, anti-static agents, coupling agents, slip agents, scavengers, biocides, and the like.

UV radiation can adversely affect substances. In embodiments, the polymeric blend of the invention includes a UV absorber (e.g. ultraviolet light absorbing agent) to assist in preventing impairment or degradation of a product's quality (e.g. food) within a thermoplastic workpiece according to the invention (e.g. a jug, a can or a bottle). Examples of suitable ultraviolet light absorbing agents include, but are not limited to Colorex™ 7074 (sold by Colorex, Granby, QC, Canada) and Mayzo BLS™ 99-2, Mayzo BLS™ 234, Mayzo BLS™ 531, Mayzo BLS™ 1130, Mayzo BLS™ 1326, Mayzo BLS™ 1328, Mayzo BLS™ 1710, Mayzo BLS™ 3035, Mayzo BLS™ 3039, Mayzo BLS™ 5411 sold by Mayzo (Suwanee, Ga., USA). In one preferred embodiment, the ultraviolet light absorbing agent is Colorex™ 7074.

In embodiments, the polymeric blend of the invention includes an oxidation catalyst, i.e. a compound that can initiate and propagate the formation of oxygen radicals in polymeric blends according to the present invention comprising a copolyester and an oxygen scavenging polyester. In embodiments, the polymeric blend comprises about 0.1% w/w to about 5% w/w oxidation catalyst, or about 0.5% w/w to about 4% w/w, or about 1% w/w to about 3% w/w, or about 1.5% w/w, or about 2% w/w, or about 2.5% w/w, or about 3% w/w. Examples of suitable oxidation catalysts include, but are not limited to OxyClear® masterbatch 2710™ by Indorama Ventures/Auriga Polymers Inc. (Charlotte, N.C., USA). In preferred embodiments, the oxidation catalysts OxyClear® masterbatch 2710™ is used in combination with the oxygen scavenging polyester OxyClear® Resin 3500.

The polymeric blend according to the invention may be obtained using any suitable method. In one embodiment, the copolyester and the oxygen scavenging polyester are obtained in bags from commercial sources in the form of solid pellets of about 8 mm in diameter. These pellets are weighted in the desired ratio then mixed and melted to obtain a melted thermoplastic composition. In embodiments, the melting and mixing is carried out at a temperature of about 230° C. to about 265° C. Depending of the desired use and desired manufacturing method (e.g. see extrusion and injection processes hereinafter), the melted thermoplastic composition may then be shaped and/or used as a paraison or a preform. Typically, in extrusion and injection blow molding apparatuses, mixing and melting is carried out simultaneously in a heated tube into which spins an endless screw.

Thermoplastic Workpieces

Numerous articles and thermoplastic workpieces may be manufactured using the polymeric blend and/or melted thermoplastic composition of the invention. Examples include, but are not limited to, containers and packaging articles for food or beverage products (e.g., maple syrup, fruit juices, wine, beer, milk, oil, jam, and any currently canned food product such as soup, meal, fruits, vegetables, etc.), pharmaceuticals and medical products (e.g. syrups, vitamins, aqueous formulations for injections, etc.), cosmetic products (e.g. lotions, creams), cleansing products (e.g. liquid soap, shampoo, disinfecting agents, etc.) and for any other application for which it is desirable to inhibit exposure to air (e.g. oxygen) or gases during storage and/or normal use.

The present invention is amenable to the manufacture of thermoplastic workpieces of different size and shape. For instance, in embodiments the container is a bottle, a jar, a jug or a can-shaped container having a volume of about 1 ml, 10 ml, 50 ml, 100 ml, 250 ml, 500 ml, 1 l, 1.5 l, 2 l, 5 l or 10 liters or more. The invention may also be used for the manufacture of even larger containers such as buckets and barrels (e.g. 5 l, 10 l, 25 l, 50 l, 100 liters or more).

In addition, containers according to the present invention could potentially find applications for storing chemicals, corrodible metals, and electronic devices. The polymeric blend and melted thermoplastic composition of the invention may also find additional industrial, commercial, medical and/or residential applications including, but are not limited to the manufacture of hollow bodied workpieces (e.g. pipes, toys, electronic devices, etc.), films, wraps (e.g., meat wraps), liners (e.g., crown, cap, or closure liners), coatings, trays, and flexible bags, etc. Although the polymeric blend of the invention is devised for the manufacture of monolayer articles, it may be envisioned to manufacture a multilayer article that includes the polymeric blend of the invention in one or more layers.

In embodiments, the thermoplastic workpiece according to the invention (e.g. bottle, container, etc.) is devised for food- and/or pharmaceutical-related applications. As such, the thermoplastic workpiece preferably complies with food contact legislations (e.g. U.S. FDA). For such food-safe applications the components entering into the composition of the polymeric blend, melted thermoplastic composition and/or final thermoplastic workpiece (e.g. the copolymer, the oxygen scavenging polyester, additives, etc.) are preferably BPA-free, halogen-free, free of any plasticizing agent and not contain any ingredients that may be toxic, cancerigen and/or cause endocrine disruption.

Thermoplastic containers according to the invention may find numerous storing applications, including short term and long term storage. Accordingly, a related aspect of the invention concerns methods for storing products. According to one embodiment, the method comprises the steps of:
(a) providing a thermoplastic container as defined herein;
(b) placing the product into the thermoplastic container; and
(c) hermetically sealing the thermoplastic container.

As indicated hereinbefore, various products may be stored including, but not limited to, food, beverages, pharmaceuticals, medical products, cosmetic products, and cleansing products. In preferred embodiments, the product is sensitive to ambient air.

The method is not limited to a particular shape of container and, for instance, the container may be a bottle, a jar, a jug, a can, a bucket, a barrel or any other suitable container. Any suitable means can be used for sealing the container, including, but not limited to, caps, lids, covers and the like.

Monolayer articles (and possibly multilayer articles), of the invention may be formed from polymeric blend and thermoplastic composition according to the invention using any suitable method. Examples of suitable methods include, but are not limited to extrusion processes such as extrusion blow molding, injection processes such as injection blow molding and injection stretch blow molding. Examples of suitable blow molding apparatuses include, but are not limited to, Bekum H-155 Twin-Station™, Bekum H-121 Twin-Station™, Kautec KCC5D™ and Phoenix 75U™. Additional methods and processes that may be envisioned include for instance co-extrusion, co-injection, over-injected parison, pressing, casting, rolling and molding.

A thermoplastic workpiece according to the present invention may possess numerous advantageous properties. For instance, in embodiments a thermoplastic workpiece comprising a thermoplastic monolayer composed of a mixture of at least (i) a copolyester and (ii) an oxygen scavenging polyester as described herein, possess one or more of the following properties:
a deflection temperature of at least 94° C., preferably at least 101° C.@0.455 MPa;
a deflection temperature of at least 81° C., preferably at least 85° C.@1.82 MPa;
an oxygen transmission rate (OTR) of less than about 0.4 cc/pkg·day (e.g. about 0.001 to about 0.4 cc/pkg·day, or about 0.01 to about 0.3 cc/pkg·day, or about 0.01 to about 0.2 cc/pkg·day, about 0.01 to about 0.05 cc/pkg·day, or about 0.012 cc/pkg·day) [for a workpiece having a thickness of about 0.508 mm (20 thousand of an inch)];
an hardness of Rockwell value of 110 [for a workpiece having a thickness of about 0.508 mm (20 thousand of an inch)];
a visible light transmission of about 92% [for a workpiece having a thickness of about 0.508 mm (20 thousand of an inch)];
a haze of less than about 1% [for a workpiece having a thickness of about 0.508 mm (20 thousand of an inch)]; and
fully transparent or with a hardly visible coloration (e.g. a very light blue color).

Considering its high deflection temperature, a thermoplastic workpiece according to the present invention may be filled with hot liquids or otherwise exposed to high temperatures. For instance a thermoplastic container according to the invention may be particularly useful for hot fill applications, including but not limited to bottling of maple syrup (typically at about 88° C.), food canning (typically at about 85-121° C.), etc. Similarly, it may be envisioned to manufacture medical devices made of or comprising thermoplastic workpiece(s) that may sustain heat sterilization in an autoclave (steam heated to 121-134° C. under pressure).

Preferably, the thermoplastic workpieces according to the present invention are recyclable. They may be recycled like any similar thermoplastic material (e.g. PET). For instance, the workpieces may be collected and grinded to small pieces and remelted and re-utilized in the preparation of a new melted thermoplastic composition and re-utilized in the manufacture new thermoplastic workpieces according to the invention. As such, the present invention encompasses melted thermoplastic compositions and thermoplastic workpieces obtained from recycled materials.

### EXAMPLES

### Example 1: Manufacture of 1 Liter Jugs by Blow Molding

Transparent heat-resistant transparent rigid one-liter cylindrical jugs comprising 2% w/w of an oxygen scavenging polyester were manufactured by blow molding as follow. Briefly, 1000 kg Eastman Copolyester Tritan TX1800™ granules (Eastman, Kingsport, Tenn., USA) and 20 kg of Polyone Colormatrix Amosorb™ granules (PolyOne™, Avon Lake, USA) were poured in a Bekum H-121 Twin-Station™ blowing machine (Bekum America Corporation, Williamston, Mich., USA) pre-heated at 450° F. (232° C.) [sample 1] or at 500° F. (260° C.) [sample 2]. Eastman™ and Polyone™ granules were allowed to melt in the heated tube of the blowing machine and were mixed with the rotating screw inside the heated tube.

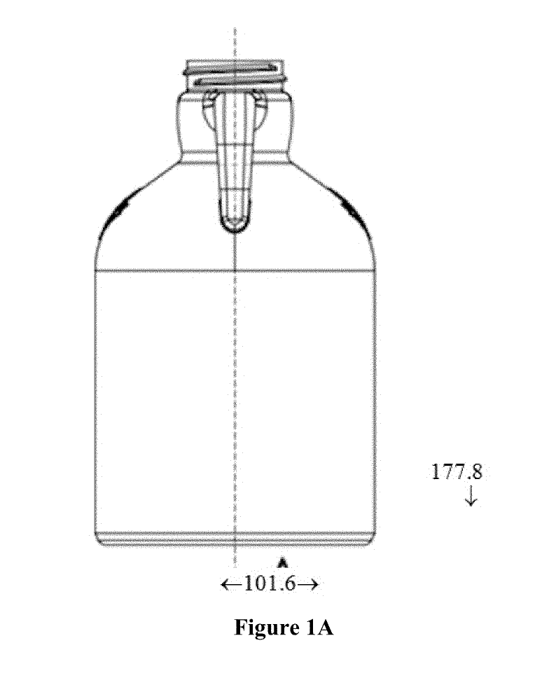

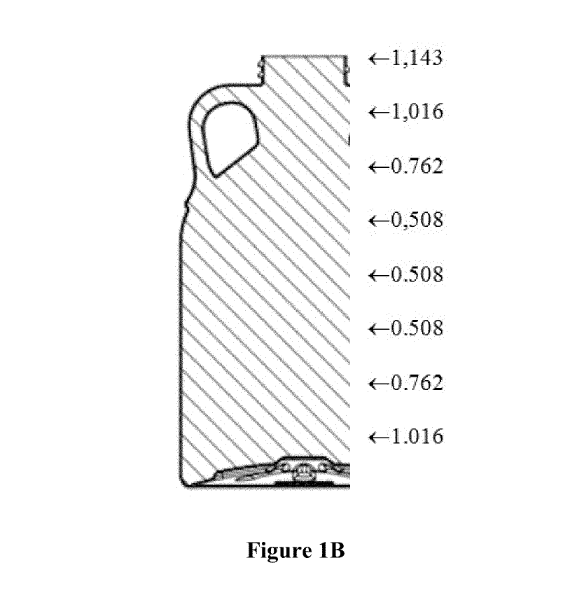

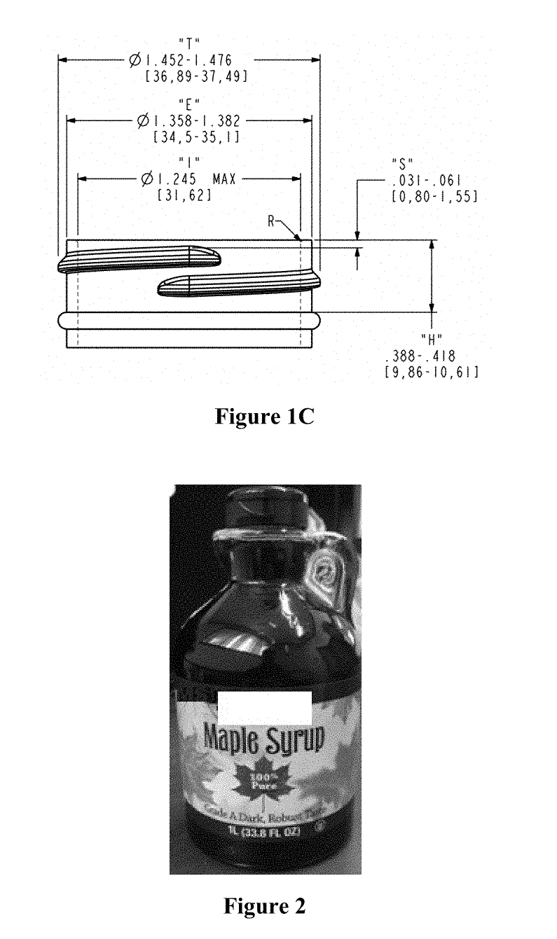

The blowing machine was coupled to a cooled mold and these were set for blowing one (1) liter cylindrical jugs using the following parameters: Temperature of the mold: 42° C.; Pre-blow pressure: 3 bar; blowing pressure: 9 bar; Torque: 56%. These specific parameters resulted in formation of jugs having thicknesses and dimensions shown in FIGS. 1A-1C.

Visual inspection of the jugs of sample 1 and sample 2 revealed that they were complete and perfectly formed, with no missing section or any hole. The neck, walls and bottom of the jugs were transparent and clear, with a very light blue color hard to see with the naked eye. The thickness of neck, walls and bottom was uniform and there was no sign of unmelted granules, suggesting that the melted paraison was homogeneous.

### Example 2: Measurement of the Gas Permeability

Oxygen transmission rate (OTR) was determined for the jugs of sample 1. To measure OTR of jugs without screw caps, the neck of two jugs was covered by a plate of aluminum and sealed with epoxy glue. Measurements were carried out according to the standard test method (norm ASTM D3985-05 (2010)) for oxygen gas transmission rate through plastic film and sheeting by using a colorimetric sensor (OX-TRAN™ Model 2/21). The temperature was 23° C., relative humidity 20% and oxygen level 21%. The measured values were next corrected to 100% O₂.

The Oxygen transmission rate for the two jugs was 0.0131 cc/pkg·day and 0.0116 cc/pkg·day respectively, for a mean of about 0.012 cc/pkg·day. These results suggest that the jugs have a very low gas permeability, a gas permeability almost as low as glass (known to have an OTR of 0 cc/pkg·day). As shown in Table 1, the gas permeability or OTR of the jugs according to the present invention also compared very favorably with other plastics materials:

TABLE 1
OTR of various existing plastics materials*

| | Permeability@20° C., |
|---|---|
| | 65% RH |
| Materials | (cc · 20 μm/m2 · day · atm) |
| EVAL ™ F series resins (Kuraray Co. Ltd.) | 0.4 |
| EVAL ™ E series resins (Kuraray Co. Ltd.) | 1.5 |
| Polyvinylidene chloride (PVDC) copolymer | 2.6 |
| (extrusion grade) | |
| Oriented nylon | 38 |
| Oriented PET | 54 |
| High density Polyethylene (HdPE) | 2 300 |
| Cast polypropylene (PP) | 3 000 |
| Polycarbonate (Pc) | 5 000 |
| Low density polyethylene (LdPE) | 10 000 |

*Values taken from a commercial brochure about Eval ™ resins (rev August 2012) published by Kuraray co. Ltd (Houston, TX, USA).

### Example 3: Drop Test

Drop impact resistance was determined for the jug of sample 1. Briefly the jug was filled with water up to about three-quarters and the cap was screwed. The jug was dropped from a height of 4 feet (1.2 m), three times on its bottom and three times on each of its two sides (the side having the handle and the side opposite to the handle).

The jug easily passed the test since it didn't break and it didn't show any visible crack after all these drops.

### Example 4: Top-Load Testing

The jug of sample 1 was submitted to a top-load test to evaluate its structural resistance to a compressive load and its risk of deformation or collapse.

Briefly, jugs were filled completely with two different hot liquids (i.e. maple syrup or vegetable oil at 195° F. (90° C.)) and the cap was screwed. A weight of 20 pounds (9 Kg) was applied on top of the hot-filled jugs for 10 minutes. The jugs filled with either of the two hot liquids passed the test since they didn't show any sign of deformation during the 10-min duration of the test.

### Example 5: Manufacture of 387-ml Jugs

Transparent heat-resistant transparent rigid 387-ml jugs were manufactured and compared for Oxygen transmission rate (OTR). These bottles comprised 97.3% w/w or 97.2% w/w JMS808™ as the copolyester and 1.5% w/w OxyClear® Resin 3500 as the oxygen scavenging polyester. The bottles also comprised 1.2% w/w or 1.3% w/w of the oxidation catalyst OxyClear® masterbatch 2710™.

Briefly, granules of JMS808™, granules of OxyClear® Resin 3500 (Indorama Ventures/Auriga Polymers Inc., Charlotte, N.C., USA) and granules of OxyClear® masterbatch 2710™ (Indorama Ventures/Auriga Polymers Inc., Charlotte, N.C., USA) were weighted to obtain a mixture having one of the following desired final concentrations: (1) 97.3% JMS808™, 1.2% Oxyclear 2710™ 1.5% Oxyclear 3500™; or (2) 97.3% JMS808™, 1.2% Oxyclear 2710™, 1.5% Oxyclear 3500 (see samples A-F in Table 2 hereinafter). Prior to melting, the granules were air dried in a Drymax E300™ (Wittmann, Germany) for 6 to 7 hours using the following parameters: granules moisture levels: below 20 ppm; drying temperature: between 177°-180° C.; air flow: 3.8 m³/hr for each Kg/hr of granules throughput; dried air dew point target: −40° C. (−40° F.). The dried granules were then poured in a blow molding machine Bekum H155™ (Bekum America Corporation, Williamston, Mich., USA). The blow molding machine was pre-heated at 290° C. and the granules mixed and allowed to melt in the heated tube of the shuttle machine and were mixed with the rotating screw inside the heated tube.

The blowing machine was coupled to a cooled mold. The blowing machine and the mold were set for blowing one cylindrical 387-ml jug at the time, using the following parameters: Temperature of the mold: 43° C.; Pre-blow pressure: 3 bar; blowing pressure: 9 bar; Torque: 56%.

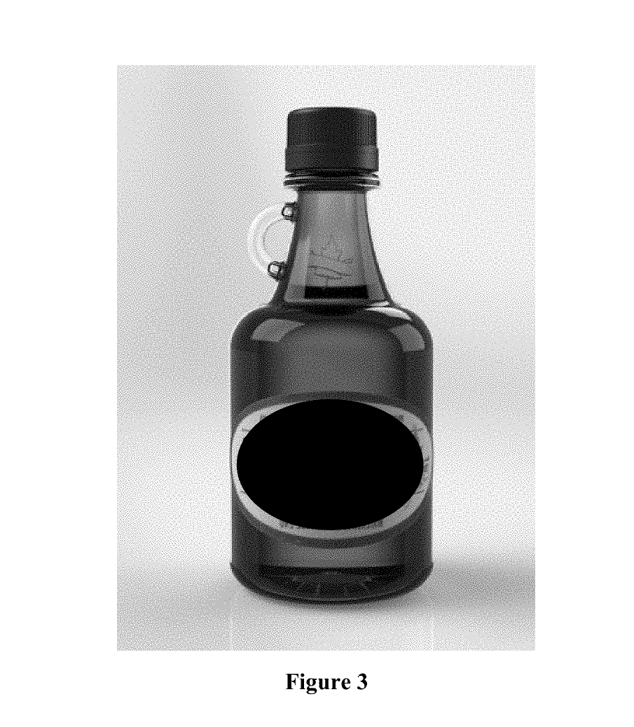

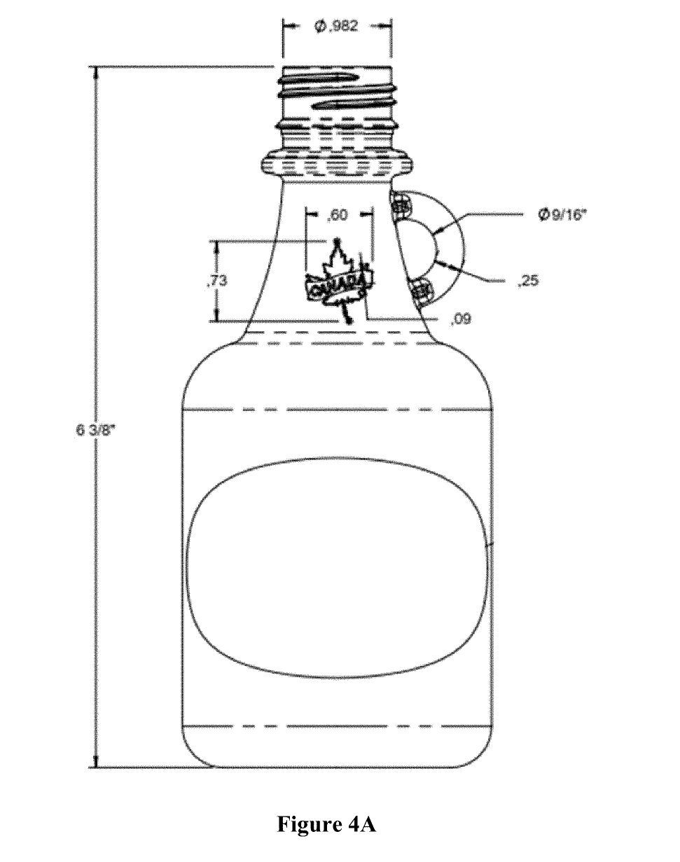

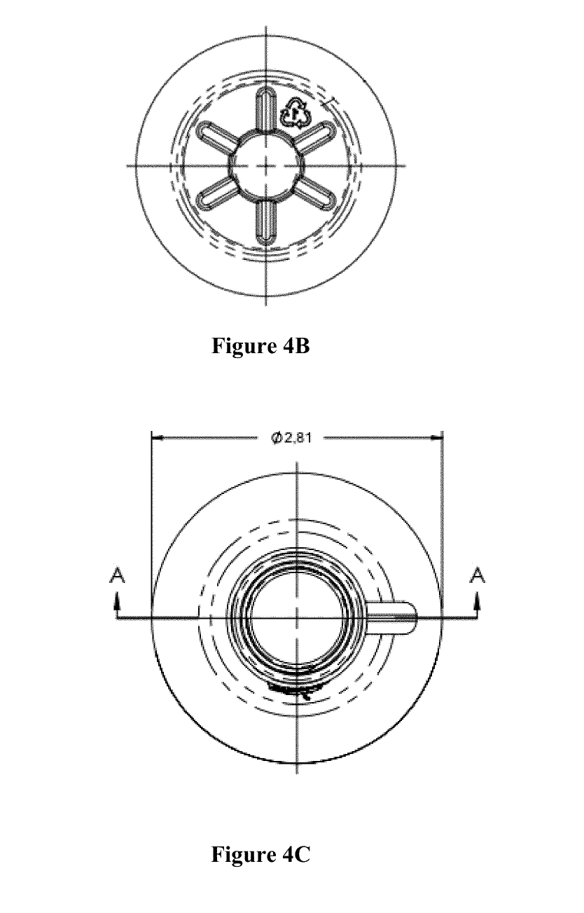

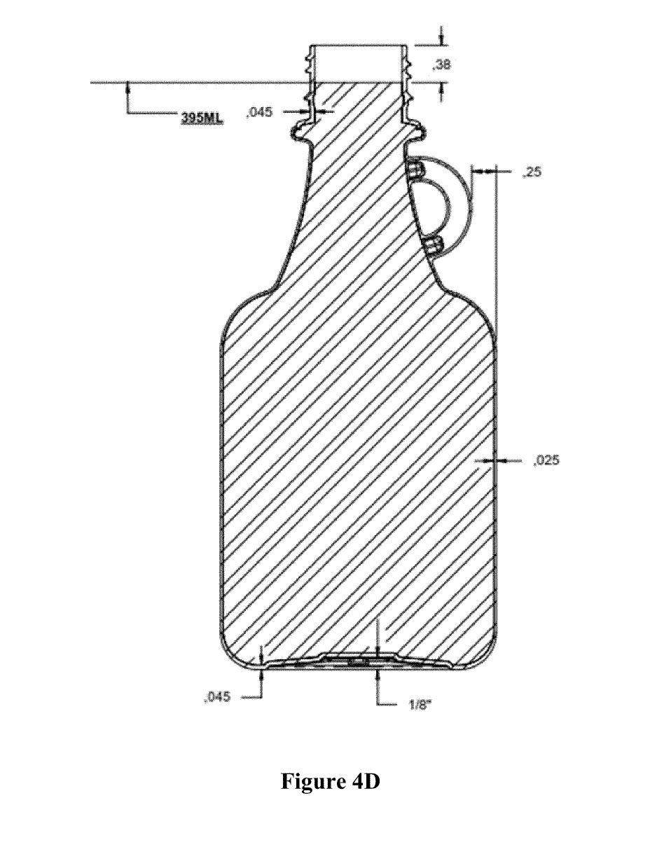

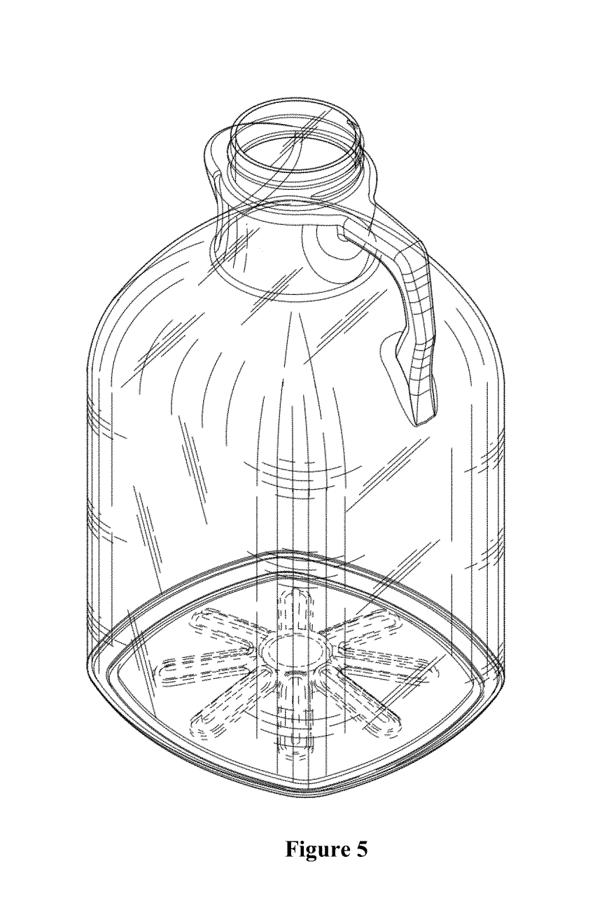

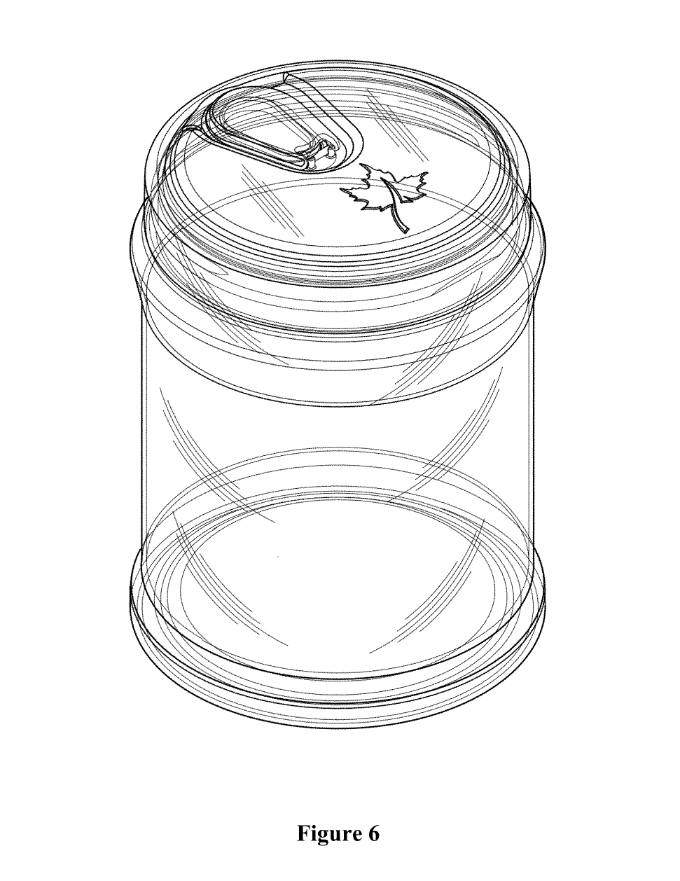

These specific parameters resulted in formation of 387-ml jugs illustrated in FIG. 3 and FIGS. 4A-D.

The jugs were submitted to accelerated 8-days physical aging or 16-days physical aging according to the ASTM F1980 standard guidelines and methodology, for obtaining jugs having an equivalent of 115 days or 230 days of physical aging, respectively.

Thereafter, Oxygen transmission rate (OTR) of the newly manufactured and of physically aged bottles, as well as of a PET control bottle (Auriga Polymers Inc., Charlotte, N.C., USA) was tested using a procedure in accordance with Example 2. The gas permeability or OTR of the newly manufactured aged and control jugs is presented in Table 2.

TABLE 2
Oxygen transmission rate (OTR) of 387-ml jugs

| | | Days of | | |
|---|---|---|---|---|
| | | physical | Measured | |
| | | aging | OTR | |
| | | (days | cc0₂/ | |
| Sample | Components | equivalent) | pkg/day | Remarks |
| Control | PET | 0 | 0.0400 | Normal |
| Sample | | | | OTR for |
| | | | | PET |
| Sample A | 97.3% JMS808 | 0 | 0.0085 | OTR 4.5 X |
| | 1.2% Oxyclear 2710 | | | better than |
| | 1.5% Oxyclear 3500 | | | control |
| Sample B | 97.3% JMS808 | 8 days | 0.0062 | OTR 6.5 X |
| | 1.2% Oxyclear 2710 | accelerated | | better than |
| | 1.5% Oxyclear 3500 | aging | | control |
| | | (115 days) | | |
| Sample C | 97.3% JMS808 | 16 days | 0.0118 | OTR 3 X |
| | 1.2% Oxyclear 2710 | accelerated | | better |
| | 1.5% Oxyclear 3500 | aging | | than control |
| | | (230 days) | | |
| Sample D | 97.2% JMS808 | 0 | 0.0064 | OTR 6.5 X |
| | 1.3% Oxyclear 2710 | | | better than |
| | 1.5% Oxyclear 3500 | | | control |
| Sample E | 97.2% JMS808 | 8 days | 0.0029 | OTR 14 X |
| | 1.3% Oxyclear 2710 | accelerated | | better than |
| | 1.5% Oxyclear 3500 | aging | | the control |
| | | (115 days) | | sample |
| Sample F | 97.2% JMS808 | 16 days | 0.0047 | OTR 9 X |
| | 1.3% Oxyclear 2710 | accelerated | | better |
| | 1.5% Oxyclear 3500 | aging | | than control |
| | | (230 days) | | |

As shown in Table 2, the OTR of jugs manufactured using a combination of JMS808™, OxyClear® Resin 3500 and OxyClear® masterbatch 2710™ was much lower than that of the PET control. That particular combination also provided jugs with OTRs lower than that of the jugs manufactured in Example 1, suggesting that the additional presence of an oxidation catalyst is beneficial. The benefits of the oxidation catalyst are further confirmed by the fact the 3 samples comprising 1.3% OxyClear® masterbatch 2710™ had lower OTRs than those comprising less, i.e. 1.2%, of the oxidation catalyst (see samples D-F vs samples A-C in Table 2). However, since samples D-F comprising 1.3% OxyClear® masterbatch 2710™ had a more pronounced blue color than samples A-C (data not shown), using lower concentrations of the oxidation catalyst may be preferred for commercial use.

### Example 6: Drop Test

Drop impact resistance was determined for the newly manufactured jugs of samples A and D. The drop test was carried out in accordance to Example 3 from a height of 4 feet (1.2 m), by dropping the filled jugs once on their bottom and once on their side. The two jugs easily passed the test since they didn't break and they didn't show any visible crack after the drops.

Headings are included herein for reference and to aid in locating certain sections. These headings are not intended to limit the scope of the concepts described therein, and these concepts may have applicability in other sections throughout the entire specification. Thus, the present invention is not intended to be limited to the embodiments shown herein but is to be accorded the widest scope consistent with the principles and novel features disclosed herein.

The singular forms “a”, “an” and “the” include corresponding plural references unless the context clearly dictates otherwise. Thus, for example, reference to “a compound” includes one or more of such compounds and reference to “the method” includes reference to equivalent steps and methods known to those of ordinary skill in the art that could be modified or substituted for the methods described herein.

Unless otherwise indicated, all numbers expressing quantities of ingredients, reaction conditions, concentrations, properties, and so forth used in the specification and claims are to be understood as being modified in all instances by the term “about”. At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contains certain errors resulting from variations in experiments, testing measurements, statistical analyses and such.

It is understood that the examples and embodiments described herein are for illustrative purposes only and that various modifications or changes in light thereof will be suggested to persons skilled in the art and are to be included within the present invention and scope of the appended claims.

1. A polymeric blend comprising: a copolyester and an oxygen scavenging polyester, wherein said copolyester has a deflection temperature of at least 81° C.@1.82 MPa and/or a deflection temperature of at least 94° C.@0.455 MPa.

2. The polymeric blend of claim 1, wherein said copolyester is a copolyester commercially available for blow molding applications.

3. The polymeric blend of claim 1, wherein said copolyester is selected from the group consisting of JMS808™, Eastman Copolyester Tritan TX1000™, Eastman Copolyester Tritan TX1001™, Eastman Copolyester Tritan TX1001™, Eastman Copolyester Tritan TX1500HF™, Eastman Copolyester Tritan TX1501HF™, Eastman Copolyester Tritan TX1800™, Eastman Copolyester Tritan TX1801™, Eastman Copolyester Tritan TX2000™, Eastman Copolyester Tritan TX2001™ and Eastman Copolyester Tritan TXF1021™.

4. The polymeric blend of claim 1, wherein said oxygen scavenging polyester is an oxygen scavenging polyester commercially available for polyethylene terephthalate (PET) applications.

5. (canceled)

6. The polymeric blend of claim 1, wherein said oxygen scavenging polyester is selected from the group consisting of OxyClear® Resin 3500, Polyone Colormatrix Amosorb™, Polyone Colormatrix Plus™, and Polyone Colormatrix SOLO2™.

7. (canceled)

8. The polymeric blend of claim 1, wherein said copolyester is JMS808™ and wherein said oxygen scavenging polyester is Polyone Colormatrix Amosorb™ OxyClear® Resin 3500.

9. The polymeric blend of claim 1, wherein said polymeric blend comprises about 0.1% w/w to about 8% w/w of said oxygen scavenging polyester.

10-13. (canceled)

14. The polymeric blend of claim 1, wherein said polymeric blend further comprises at least one additive selected from the group consisting of: oxidation catalysts, visible light absorbers, dyes, colorants, metallic oxidation catalysts, fillers, processing aids, plasticizers, fire retardants, anti-fog agents, crystallization aids, impact modifiers, surface lubricants, denesting agents, stabilizers, antioxidants, ultraviolet light absorbing agents, catalyst deactivators, nucleating agents, acetaldehyde reducing compounds, reheat enhancing aids, anti-abrasion additives, anti-static agents, coupling agents, slip agents, scavengers, and biocides.

15. (canceled)

16. The polymeric blend of claim 14, wherein said ultraviolet light absorbing agent is Colorex™ 7074.

17. (canceled)

18. A polymeric blend comprising JMS808™ and Polyone Colormatrix Amosorb™.

19. A melted thermoplastic composition comprising a mixture of (i) a melted copolyester and (ii) a melted oxygen scavenging polyester, wherein said melted plastic composition has a melting temperature of about 230° C. to about 265° C.

20. The melted thermoplastic composition of claim 19, wherein said melted thermoplastic composition comprises about 0.5% w/w to about 5% w/w of said oxygen scavenging polyester.

21. The melted thermoplastic composition of claim 19, wherein said copolyester has a deflection temperature of at least 81° C.@1.82 MPa and/or a deflection temperature of at least 94° C.@0.455 MPa.

22. The melted thermoplastic composition of claim 19, wherein said melted thermoplastic composition consists of a paraison or a preform.

23. The melted thermoplastic composition of claim 19, wherein said mixture further comprises (iii) 1% w/w to about 3% w/w of an oxidation catalyst.

24. (canceled)

25. A thermoplastic workpiece, comprising a thermoplastic monolayer composed of at least (i) a copolyester and (ii) an oxygen scavenging polyester, wherein said copolyester has a deflection temperature of at least 81° C.@1.82 MPa and/or a deflection temperature of at least 94° C.@0.455 MPa.

26. The thermoplastic workpiece of claim 25, wherein said copolyester is selected from the group consisting of JMS808™, Eastman Copolyester Tritan TX1000™, Eastman Copolyester Tritan TX1001™, Eastman Copolyester Tritan TX1001™, Eastman Copolyester Tritan TX1500HF™, Eastman Copolyester Tritan TX1501HF™, Eastman Copolyester Tritan TX1800™, Eastman Copolyester Tritan TX1801™, Eastman Copolyester Tritan TX2000™, Eastman Copolyester Tritan TX2001™ and Eastman Copolyester Tritan TXF1021™.

27. The thermoplastic workpiece of claim 25, wherein said oxygen scavenging polyester is selected from the group consisting of OxyClear® Resin 3500, Polyone Colormatrix Amosorb™, Polyone Colormatrix Plus™, and Polyone Colormatrix SOLO2™.

28. The thermoplastic workpiece of claim 25, wherein said thermoplastic monolayer comprises about 0.1% w/w to about 8% w/w of said oxygen scavenging polyester.

29. The thermoplastic workpiece of claim 25, wherein said thermoplastic monolayer further comprises at least one additive selected from the group consisting of: oxidation catalysts, visible light absorbers, dyes, colorants, metallic oxidation catalysts, fillers, processing aids, plasticizers, fire retardants, anti-fog agents, crystallization aids, impact modifiers, surface lubricants, denesting agents, stabilizers, antioxidants, ultraviolet light absorbing agents, catalyst deactivators, nucleating agents, acetaldehyde reducing compounds, reheat enhancing aids, anti-abrasion additives, anti-static agents, coupling agents, slip agents, scavengers, and biocides.

30. (canceled)

31. The melted thermoplastic composition of claim 29, comprising about 1% w/w to about 3% w/w of the oxidation catalyst.

32. The thermoplastic workpiece of claim 25, wherein said thermoplastic workpiece comprises at least one of the following properties:
a deflection temperature of at least 94° C.@0.455 MPa;
a deflection temperature of at least 81° C.@1.82 MPa;
an oxygen transmission rate (OTR) of less than about 0.04 cc/pkg·day for a workpiece having a thickness of about 0.508 mm (20 thousand of an inch);
an hardness of Rockwell value of 110 for a workpiece having a thickness of about 0.508 mm (20 thousand of an inch);
a visible light transmission of about 92% for a workpiece having a thickness of about 0.508 mm (20 thousand of an inch); and
a haze of less than about 1% for a workpiece having a thickness of about 0.508 mm (20 thousand of an inch).

33. A method of manufacturing a thermoplastic workpiece comprising:
melting and mixing (i) an amorphous copolyester having a deflection temperature of at least 81° C.@1.82 MPa and/or a deflection temperature of at least 94° C.@0.455 MPa with (ii) a compatible oxygen scavenging polyester for obtaining the polymeric blend according to claim 1; and
mechanically shaping the polymeric blend into said thermoplastic workpiece.

34. The method of claim 33, wherein said mechanically shaping comprises a process selected from the group consisting of extrusion blow molding, injection blow molding and injection stretch blow molding.

35. The method of claim 33, wherein said melting and mixing comprises melting and mixing said copolyester and said scavenging polyester at a temperature of about 230° C. to about 265° C.

36. (canceled)

37. A thermoplastic container comprising a thermoplastic monolayer composed of a mixture of at least (i) a copolyester and (ii) about 0.5% w/w to about 5% w/w of an oxygen scavenging polyester, wherein said copolyester has a deflection temperature of at least 81° C.@1.82 MPa and/or a deflection temperature of at least 94° C.@0.455 MPa.

38. (canceled)

39. The thermoplastic container of claim 37, wherein said copolyester is selected from the group consisting of JMS808™, Eastman Copolyester Tritan TX1000™, Eastman Copolyester Tritan TX1001™, Eastman Copolyester Tritan TX1001™, Eastman Copolyester Tritan TX1500HF™, Eastman Copolyester Tritan TX1501HF™, Eastman Copolyester Tritan TX1800™, Eastman Copolyester Tritan TX1801™, Eastman Copolyester Tritan TX2000™, Eastman Copolyester Tritan TX2001™ and Eastman Copolyester Tritan TXF1021™.

40. The thermoplastic container of claim 37, wherein said oxygen scavenging polyester is selected from the group consisting of OxyClear® Resin 3500, Polyone Colormatrix Amosorb™, Polyone Colormatrix Plus™, and Polyone Colormatrix SOLO2™.

41. The thermoplastic container of claim 37, wherein said thermoplastic monolayer further comprises at least one additive selected from the group consisting of: oxidation catalysts, visible light absorbers, dyes, colorants, metallic oxidation catalysts, fillers, processing aids, plasticizers, fire retardants, anti-fog agents, crystallization aids, impact modifiers, surface lubricants, denesting agents, stabilizers, antioxidants, ultraviolet light absorbing agents, catalyst deactivators, nucleating agents, acetaldehyde reducing compounds, reheat enhancing aids, anti-abrasion additives, anti-static agents, coupling agents, slip agents, scavengers, and biocides.

42. (canceled)

43. (canceled)

44. The thermoplastic container of claim 42, wherein said thermoplastic container further comprises an ultraviolet light absorbing agent.

45. (canceled)

46. (canceled)

47. The thermoplastic container of claim 37, wherein said container consists of a bottle, a jug, a jar, a can, a bucket, or a barrel.

48. (canceled)

49. A thermoplastic container in the form of a bottle, a can or a jug, said container comprising a thermoplastic monolayer composed of a mixture of JMS808™ and Polyone Colormatrix Amosorb™.

50-55. (canceled)
